(19) United States
(12) Patent Application Publication
(10) Pub. No.: US 2010/0274528 A1
(43) Pub. Date: Oct. 28, 2010

(54) Field device with measurement accuracy reporting

(75) Inventors: Gregory Jacques Lecuyer, Eden Prairie, MN (US); David L. Wehrs, Eden Prairie, MN (US); David J. Kent, Climping (GB)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Rosemount Inc., Eden Prairie, MN (US)

(21) Appl. No.: 12/386,760

(22) Filed: Apr. 22, 2009

(51) Int. Cl. G06F 15/00

(52) U.S. Cl. 702/183

(57) ABSTRACT

A field device includes a sensor for sensing a process parameter, a processor for producing a measurement value as a function of the sensed process parameter, and a communication interface for transmitting an output based upon the measurement value. The processor also calculates a measurement precision value associated with the measurement value.

### BACKGROUND

The present invention relates generally to field devices for use in industrial process control systems. More particularly, the present invention relates to field devices capable of providing a measurement value representing a measured process parameter and a measurement precision value representing measurement uncertainty of the process parameter.

Field devices include a broad range of process management devices designed to measure and control process parameters such as pressure, temperature, flow rate, level, conductivity, and pH. These devices have broad utility in a variety of industries, including manufacturing, hydrocarbon processing, hydraulic fracturing and other liquid hydrocarbon extraction techniques, bulk fluid handling, food and beverage preparation, water and air distribution, environmental control, and precision manufacturing applications for pharmaceuticals, glues, resins, thin films, and thermoplastics.

Field devices include process transmitters (which are configured to measure or sense process parameters) and process controllers (which are configured to modify or control such parameters in order to achieve a target value). More generalized field devices include multi-sensor transmitters such as pressure/temperature transmitters and integrated controllers with both sensor and control functionality. These generalized devices include integrated flow controllers and hydrostatic tank gauge systems, which measure and regulate a number of related process pressures, temperatures, fluid levels and flow rates.

Flowmeters and associated transmitters fill an important role in fluid processing, and they employ a wide variety of different technologies. These include, but are not limited to, turbine flowmeters that characterize flow as a function of mechanical rotation, differential pressure sensors that characterize flow as a function of pressure, mass flowmeters that characterize flow as a function of thermal conductivity, and vortex or Coriolis flowmeters that characterize flow as a function of vibrational effects, and magnetic flowmeters that rely upon the conductivity of the process fluid, such as water containing ions, and the electromotive force induced across the fluid as it flows through a region of magnetic field.

It is frequently desirable to perform checks or diagnostics of the process control loop to verify operation and performance of each field device within the control loop. More particularly, it is desirable to verify performance of each transmitter remotely from the control room without performing invasive procedures on the control loop or physically removing the transmitter from the control loop and industrial process control system. Currently, diagnostic capabilities are limited to obtaining information relating only to performance of the control loop and transmitter electronics. For example, the control room is able to initiate a test signal that originates from the transmitter electronics and then propagates throughout the control loop. The control room, knowing the magnitude and quality of the initiated test signal, can verify that the control loop and transmitter respond properly to the test signal. The control room thus mimics sensor output and checks that the electronics and control loop respond in kind. The control loop, however, is not able to verify functionality of the sensor, which can be affected by external influences and time. For example, the mimicked test signal does not verify if the sensor is undamaged and producing a valid pressure signal.

It is common for data representing the measurements made by field devices to be stored, so that it can later be reviewed. Paper charts, for example, may be used to show one or more of the process parameters as a function of time. The compiled data may also be made available to government regulatory bodies or to business interested parties (such as utility companies, commodity consumers, chemical manufacturers regulated by government agencies, and customers that are regulated by agencies such as the Food and Drug Administration and the Environmental Protection Agency). The compiled data does not, however, indicate the accuracy of the transmitter at the time that the measurements were made.

In terms of performance, engineers and buyers generally select field devices (e.g. process transmitters) based upon their published reference accuracy. When installed, the accuracy of measurement values from the field device will depend on a number of factors in addition to reference accuracy. These factors may include errors associated with the field device, as well as errors associated with a primary element (such as an orifice plate or a bluff body) used to create a measurable signal to be sensed by the field device. The errors may arise from temperature effects, line pressure effects, long term drift, and out-of-range (e.g. overpressure) exposure that affects calibration.

As a result, when a field device is in service, the actual operating accuracy is not known. Although the process should have a required performance (or allowable error) associated with measurement of process parameters, it has been difficult to determine whether the field devices are operating within those limits at any given time.

### SUMMARY

A field device includes a sensor for sensing a process parameter, a processor for producing a measurement value as a function of the sensed process parameter, and a communication interface for transmitting an output based upon the measurement value. The processor also calculates a measurement precision value associated with the measurement value.

In one embodiment, the measurement precision value includes a total probable error and a stability error. The processor compares the measurement precision value to a stored required performance limit, and the communication interface provides an indication of whether the measurement precision value is within the required performance limit.

### BRIEF DESCRIPTION OF THE DRAWINGS

FIG. 1 is a block diagram of a field device capable of real time computation of total probable error and stability error, and reporting a measurement precision value as an indication of real operating accuracy based upon the computation.

FIG. 2 is a flow diagram illustrating computation of total probable error and stability error by a field device.

### DETAILED DESCRIPTION

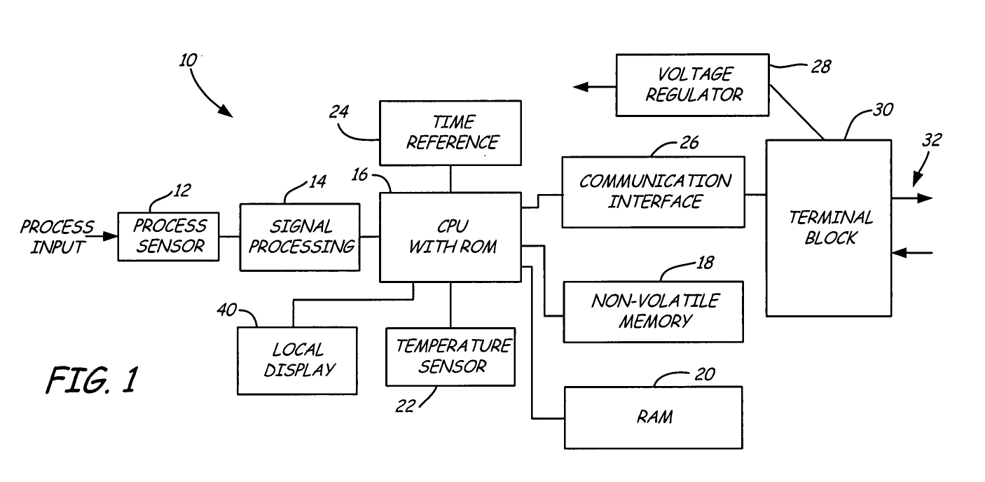

FIG. 1 is a block diagram illustrating field device 10, which includes process sensor module 12, signal processing circuitry 14, central processing unit (CPU) 16, non-volatile memory 18, random access memory (RAM) 20, temperature sensor 22, time reference circuit 24, communication interface 26, voltage regulator 28, and terminal block 30. Field device 10 is connected to communication medium 32 at terminal block 30. Communication medium 32 may be a two wire twisted pair capable of carrying an analog 4 to 20 milliamp current representative of a sensed process parameter as well as digital communication using, for example, the HART communication protocol. Alternatively, communication medium 32 may be a communication bus over which two way digital communication is provided using a communication protocol such as Foundation Fieldbus. Communication can also be provided by a wireless communication protocol such as wireless HART.

Process sensor module 12 senses a process parameter (or process variable) and provides a sensor signal to signal processing circuitry 14. The process parameter can be, for example, differential pressure, gage pressure, absolute pressure, temperature, flow rate, liquid level, conductivity, pH, or another process parameter of interest. In some cases, process sensor module 12 may include multiple sensors that sense multiple process parameters.

Signal processing circuitry 14 typically includes analog-to-digital conversion circuitry, as well as filtering and other signal processing to place sensor signal into a format that can be used by CPU 16. For example, signal processing circuitry 14 may include one or more sigma-delta analog-to-digital converters and digital filters to provide digitized and filtered sensor signals to CPU 16.

CPU 16 coordinates the operation of field device 10. It processes data received; it receives and stores sensor signals generated by process sensor module 12 and signal processing circuitry 14; and it generates measurement values that are provided through communication interface 26 and terminal block 30 onto communication medium 32. The measurement values represent values of the process parameter(s) sensed by process sensor module 12. In addition, CPU 16 uses temperature data from temperature sensor 22 and a time reference from time reference circuit 24, together with coefficients stored in non-volatile memory 18 to calculate measurement precision values, such as a total probable error (TPE) and a stability error (SE) associated with the measurement value. Upon a request received from the control room, the total probable error and the stability error can be reported over communication medium 32 or communicated as a secondary variable with each communication. In addition, another measurement precision value, the total calculated error, representing the sum of the total probable error and the stability error, can be compared by CPU 16 to a required performance limit stored in non-volatile memory 18. If the total calculated error exceeds the required performance, CPU 16 can cause an alert or an alarm to be generated and transmitted over communication medium 32. The determination of whether an alert or an alarm is generated can be a user choice that is stored in non-volatile memory 18.

CPU 16 may also monitor the sensor signals to determine whether an out-of-range condition has occurred that can impact measurement uncertainty. For example, exposure of a pressure sensor to a high overpressure condition can affect calibration, so that recalibration of field device 10 may be required earlier then ordinarily expected.

CPU 16 is typically a microprocessor with associated memory, such as non-volatile memory 18 and RAM 20. Other forms of memory, such as flash memory, may also be used in conjunction with CPU 16.

Non-volatile memory 18 stores application programming used by CPU 16, including programming required to perform a diagnostic routine to determine operating accuracy. Non-volatile memory 18 stores coefficients and constants used in calculation of total probable error and stability error, and the required performance limit. In addition, non-volatile memory 18 stores configuration data, calibration data, and other information required by CPU 16 to control operation of field device 10.

Temperature sensor 22 senses temperature within the housing of field device 10. The temperature sensed by temperature sensor 22 is used by CPU 16 in determining a temperature effect, which is a component of the total probable error.

Time reference 24 provides an operating time reference used in stability error calculation. Time reference 24 may provide a real time clock value, or may provide a time reference value representing a time elapsed since the last calibration of field device 10 or time elapsed since the field device was installed (service life).

Communication interface 26 serves as an interface of field device 10 with the loop or network formed by communication medium 32. Communication interface 26 may provide analog as well as digital outputs based upon data received from CPU 16. Communication interface 26 also receives messages from communication medium 32, and provides those messages to CPU 16.

Voltage regulator 28 is connected to terminal block 30, and derives regulated voltage used to power all components of field device 10. In the embodiment shown in FIG. 1, field device 10 transmits and receives information over a wired communication medium, and also receives power from communication medium 32. In other embodiments, field device 10 may be a wireless field device, in which case power may be supplied to voltage regulator 28 by a battery or energy scavenging device associated with field device 10, or from a wired power bus that does not carry communications. In that case, communication interface 26 will include a wireless transceiver.

The calculation of the measurement precision values associated with measurement values from field device 10 can be performed periodically or in response to particular events, such as each time a new measurement value is available. CPU 16 makes use of coefficients stored in non-volatile memory 18 in calculating total probable error TPE and stability error SE. The coefficients may be hard coded in ROM of CPU 16, or may be loaded in non-volatile memory 18 at the time of manufacture.

Total probable error (TPE_{T}) of field device 10 can be expressed as:

$$T P {E}_{T} = \sqrt{{( Rf . Acc )}^{2} + {( Temp . Effect )}^{2} + {( Static . Effect )}^{2}} \qquad Eq . 1$$

Rf.Acc is the reference accuracy of the field device. The reference accuracy is a sensor specific value stored in non-volatile memory, which depends upon the current operating range of the field device. The current operating range can be defined in terms of an upper range limit and a range span that are stored in non-volatile memory 18 during configuration of field device 10.

Temp.Effect is an error component that varies as a function of the temperature of the field device. Temperature sensor 22 provides a temperature value to CPU 16. That temperature reading is applied to a coefficient stored in non-volatile memory 18 to yield error component Temp.Effect.

Static.Effect is an error component related to static line pressure. This error component will be present, for example, in field devices that provide measurement values relating to pressure or fluid flow. In other types of field devices, such as temperature transmitters, the static effect component is not present in the calculation of total probable error (TPE_{T}). For field devices having multiple parameter sensing capability (including sensing of static line pressure), Static.Effect may be calculated by multiplying a stored coefficient from non-volatile memory 18 times the measured static line pressure. For field devices without the ability to sense static line pressure, Static.Effect can be based upon a pre-entered user range value representing the range of static line pressure expected for an operation of a field device. This user range value will typically be entered and stored in non-volatile memory 18 during configuration of the field device. Alternatively, if a gage pressure transmitter is present on the same network as field device 10, static pressure could be received as an input over the network from the gage pressure transmitter.

For those field devices that are used in conjunction with a primary element, a calculation can also be performed to derive a total probable error associated with the primary element (TPE_{P}). In some cases, the total probable error of the primary element (TPE_{P}) can be larger than the total probable error of the field device (TPE_{T}). For example, if field device 10 is sensing differential pressure, a primary element in the form of an orifice plate will typically be used to create the differential pressure that is being sensed. A calculation of TPE for the primary element can be made, using a similar equation to Equation 1 including the Coefficient of Discharge CD. The particular coefficients used for Rf.Acc, Temp.Effect, and Static.Effect in calculating TPE_{P}, may be different than those used for calculating total probable error of the field device TPE_{T}.

Stability error (SE) is calculated based upon a stability error coefficient stored in non-volatile memory 18 and an operating time since last calibration, which is read by CPU 16 from time reference 24. The stability error will be calculated as follows:

SE=(Stability_Error_Coefficient)×(Operating_Time_since_last_calibration) Eq. 2

Total probable error of the field device TPE_{T}, total probable error of the primary element TPE_{P}, and stability error SE may be reported in response to a request received over communication medium 32, or may be reported in conjunction with each measurement value. In addition, a total calculated error TCE may also be computed and compared to a required performance limit, which represents the allowable error of the particular process in which field device 10 is being used.

Total calculated error TCE is the sum of the total probable errors and the stability error:

TCE=TPE_{T}+TPE_{P}+SE Eq. 3

In some cases, a primary element is not used, or a separate total probable error associated with the primary element is not calculated. In those cases, the total calculated error TCE is the sum of TPE_{T} and SE.

The required performance limit is user selected, and can be entered at the time of configuration of field device 10. The required performance limit is specific to the particular process in which field device 10 is used, and may be different (e.g. less stringent) than the accuracy for the field device as specified by the manufacturer.

If the total calculated error is greater than the required performance limit, then field device 10 will provide an output in the form of either an alert or an alarm. The determination of whether an alert or an alarm should be generated can be selected by the user, with that selection being stored in non-volatile memory for use by CPU 16.

When total calculated error exceeds the required performance limit, recalibration of field device 10 is required. Once recalibration has been performed, the operating time since last calibration will be reset, and therefore the stability error SE is reinitialized upon recalibration.

There is another condition that can occur which will require recalibration even though total calculated error does not exceed the required performance limit. Field device 10 may be exposed to an out-of-range (e.g. overpressure) condition that affects calibration of the field device. This out-of-range condition is a field device-specific limit, rather than a process specific limit. In other words, an out-of-range pressure may result in a process alarm, and yet not require recalibration of the field device.

When a field device-specific out-of-range limit is exceeded, CPU 16 causes an alert or alarm to be generated indicating that calibration is needed. This can be the same alert or alarm used to indicate need for calibration because the total calculated error exceeds the required performance limit.

In addition to transmitting an alarm or alert, CPU 16 can also cause communication interface 26 to send a message indicating the estimated number of hours to the next calibration. The hours to next calibration can be estimated based upon the comparison of total calculated error to the required performance limit.

In some embodiments, field device 10 may also include local display 40 (shown in FIG. 1). Information presented on local display 40 can include total calculated error, total probable error of the field device or the primary element (or both), stability error, and hours to next calibration. Local display 40 may also include a bar graph and an indicator providing a countdown to next calibration. That countdown can be based upon the comparison of total calculated error to the required performance limit. Local display 40 may also include an indication of an out-of-range condition requiring immediate recalibration of the field device.

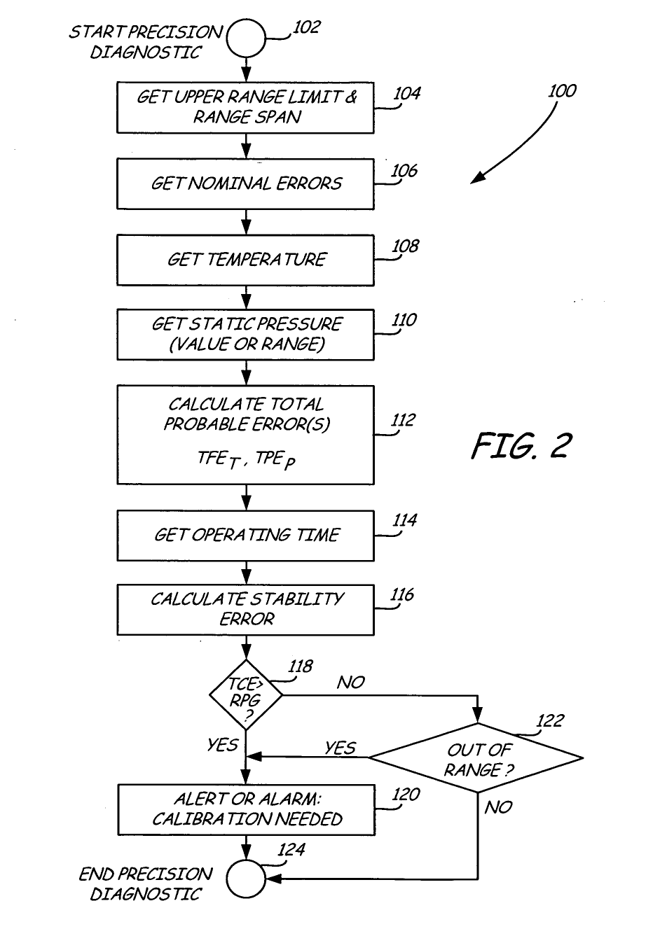

FIG. 2 is a flow diagram that illustrates one embodiment of precision diagnostic 100 performed by CPU 16 in calculating measurement precision values of total probable error, stability error, and total calculated error. Precision diagnostic 100 starts either periodically, or as a result of a particular event, such as calculation of a new measurement value (step 102).

CPU 16 gets an upper range limit and a range span of field device 10 (step 104). The upper range limit and range span are values that are stored in non-volatile memory 18, and are entered either at the time of manufacture, or during field device configuration.

CPU 16 then gets nominal errors from non-volatile memory 18 (step 106). The nominal errors that are stored include a reference accuracy (Rf.Acc) coefficient, a temperature effect (Temp.Effect) coefficient, a static pressure effect (Static.Effect) coefficient, and a stability error (SE) coefficient. These coefficients will be used in calculation of total probable error and stability error.

CPU 16 then gets a temperature value from temperature sensor 22 (step 108). The temperature value represents internal temperature of field device 10. It will be used in calculating the temperature effect (Temp.Effect) component of total probable error of the field device (TPE_{T}).

CPU 16 then gets static pressure, which may be either a value or a range (step 110). The static pressure may be a measured value from one of sensors 12, or a value from another transmitter that measures static line pressure, or a range set during configuration of field device 10 by the user.

CPU 16 then calculates total probable error (step 112). In this calculation, CPU 16 uses non-volatile coefficients such as reference accuracy coefficient, temperature effect coefficient, and static pressure effect coefficient together with the temperature measurement, the static pressure, the upper range limit, and the span. In some embodiments, the static effect is not present (such as when field device 10 is a temperature transmitter). If a primary element is used in conjunction with field device 10, CPU 16 may perform calculations twice in order to calculate a total probable error for a field device TPE_{T} and a total probable error for the primary element TPE_{P}.

CPU 16 then gets an operating time from time reference 24 (step 114). Then it calculates stability error (SE) using the stability error coefficient received from non-volatile memory 18 and the total operating time since last calibration (step 116).

Having calculated total probable error(s) and stability error, CPU 16 then sums total probable error(s) and stability error to yield total calculated error TCE. CPU 16 then compares TCE to the required performance limit RPL (step 118). If TCE is greater than the required performance limit, CPU 16 causes an alert or an alarm to be generated (step 120). The determination of whether an alert is generated or an alarm is generated will depend upon a user selection that is stored in non-volatile memory 18.

If TCE is less than or equal to the required performance limit, CPU 16 then determines whether an out-of-range condition (e.g., over pressure or over temperature) has occurred that would require recalibration (step 122). If an out-of-range condition has occurred, an alert or an alarm is generated (step 120). If an out-of-range condition has not occurred, or if the alert or alarm has been generated, precision diagnostic 100 ends (step 124).

By performing a real time calculation of total probable error(s) and stability error, field device 10 is capable of providing measurement precision values as an indication of its real operating accuracy in conjunction with the measurement values that it provides. Field device 10 makes it possible to dynamically calculate the sensor error compared to the actual process variable. As a result, the operator of a process can assess not only whether measurements indicate the processes are within prescribed limits, but also whether the field devices that make the measurements are operating within a required performance limit.

Although the present invention has been described with reference to preferred embodiments, workers skilled in the art will recognize that changes may be made in form and detail without departing from the spirit and scope of the invention.

1. A field device comprising:
a sensor for sensing a process parameter;
a processor for producing a measurement value as a function of the process parameter sensed, and calculating a measurement precision value for the measurement value based upon operating conditions of the field device; and
a communication interface for transmitting a field device measurement output based upon the measurement value and a diagnostic output based upon the measurement precision value.

2. The field device of claim 1, wherein the diagnostic output is a function of a comparison of the measurement precision value and a stored required performance limit.

3. The field device of claim 1, wherein the diagnostic output provides an indication of a need for calibration of the field device.

4. The field device of claim 3, wherein the processor identifies the occurrence of an out-of-range process parameter sensed by the sensor and causes the diagnostic output to provide an indication of a need for calibration of the field device.

5. The field device of claim 4, wherein the out-of-range process parameter is an overpressure.

6. The field device of claim 1, wherein the diagnostic output provides an indication of time until calibration of the field device is needed.

7. The field device of claim 1 and further comprising:
a local display for displaying information based upon the measurement precision value.

8. The field device of claim 7, wherein the local display displays information including at least one of total probable error of the field device, total probable error of a primary element associated with the field device, a stability error, and a total calculated error.

9. The field device of claim 7, wherein the local display displays a countdown to a next calibration of the field device.

10. The field device of claim 7, wherein the processor identifies the occurrence of an out-of-range process parameter sensed by the sensor and causes the local display to display an indication of the need for calibration of the field device.

11. The field device of claim 10, wherein the out-of-range process parameter is an overpressure.

12. The field device of claim 1, wherein the measurement precision value comprises a total probable error of the field device.

13. The field device of claim 12, wherein the total probable error is calculated by the processor based upon a stored reference accuracy of the sensor and a temperature effect related to temperature of the field device.

14. The field device of claim 13, wherein the process parameter is pressure and the total probable error is calculated by the processor based upon the stored reference accuracy, the temperature effect, and a static effect related to static line pressure.

15. The field device of claim 12, wherein the measurement precision value further comprises a total probable error of a primary element associated with the field device.

16. The field device of claim 15, wherein the total probable error of the primary element is calculated by the processor based upon a stored reference accuracy of the sensor and a temperature effect related to temperature of the field device.

17. The field device of claim 16, wherein the process parameter is pressure and the total probable error of the primary element is calculated by the processor based upon the stored reference accuracy, the temperature effect, and a static effect related to static line pressure.

18. The field device of claim 12, wherein the measurement precision value further comprises a stability error.

19. The field device of claim 18 and further comprising:
a time reference for providing an operating time reference for use by the processor in calculating the stability error.

20. The field device of claim 1, wherein the diagnostic output is transmitted as a secondary variable with each transmission of the measurement value.

21. A method of measuring process parameters, the method comprising:
sensing a process parameter;
producing a measurement value representative of the process parameter sensed;
providing a measurement output based upon the measurement value;
calculating a measurement precision value based upon stored coefficients and data related to operating conditions of the field device; and
providing a measurement precision diagnostic output based upon the measurement precision value.

22. The method of claim 21, wherein the measurement precision value includes a total probable error.

23. The method of claim 22, wherein the total probable error is a function of a reference accuracy and a temperature effect.

24. The method of claim 23, wherein the total probable error is also a function of a static effect.

25. The method of claim 22, wherein the measurement precision value includes a stability error.

26. The method of claim 21, wherein the providing measurement precision diagnostic output comprises:
comparing the measurement precision value to a required performance limit; and
producing the measurement precision diagnostic output as a function of the comparison.

27. The method of claim 21 and further comprising:
sensing occurrence of any out-of-range condition that affects calibration; and
causing the measurement precision diagnostic output to indicate a need for calibration when an out-of-range condition is sensed.

28. The method of claim 27, wherein the measurement value is a pressure value, and the out-of-range condition is an overpressure condition.

29. The method of claim 21, wherein the measurement precision diagnostic output comprises a secondary variable communicated with the measurement output.
